(19) United States
(12) Patent Application Publication
(10) Pub. No.: US 2025/0321210 A1
(43) Pub. Date: Oct. 16, 2025

(54) RESIDUAL ACID ANALYSIS METHOD FOR ALCOHOL COMPOUND

(71) Applicant: NAN YA PLASTICS CORPORATION, TAIPEI (TW)

(72) Inventors: CHING-YAO YUAN, TAIPEI (TW); WEI-SHENG CHENG, TAIPEI (TW); CHIA-CHEN SU, TAIPEI (TW); CHAO-TUNG WU, TAIPEI (TW)

(21) Appl. No.: 18/676,468

(22) Filed: May 28, 2024

(30) Foreign Application Priority Data
Apr. 11, 2024 (TW) 113113452

(51) Int. Cl. G01N 31/16; G01N 1/34; G01N 1/38

(52) U.S. Cl. CPC G01N 31/164; G01N 1/34; G01N 1/38

(57) ABSTRACT

A residual acid analysis method for an alcohol compound is provided. The residual acid analysis method includes providing an organic solvent and placing the organic solvent into a distillation apparatus to distill the organic solvent and obtain a purified organic solvent from a middle fraction of a distilled liquid distilled from the distillation apparatus; mixing an alkaline inorganic compound and at least a part of the purified organic solvent to form a titration liquid; mixing a diol compound to be measured and at least another part of the purified organic solvent to form a test sample; and using the titration liquid to perform an acid-base titration on the test sample to analyze a residual acid content of the diol compound. An equivalent concentration of the alkaline inorganic compound in the titration liquid is not greater than 0.005 N.

### CROSS-REFERENCE TO RELATED PATENT APPLICATION

This application claims the benefit of priority to Taiwan Patent Application No. 113113452, filed on Apr. 11, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an analysis method for a compound, and more particularly to a residual acid analysis method for an alcohol compound.

### BACKGROUND OF THE DISCLOSURE

In the related art, when a diol compound (e.g., a dihydroxy aromatic compound) is used as a reactant of a transesterification reaction, an alkali metal hydroxide (e.g., potassium hydroxide (KOH) or sodium hydroxide (NaOH)) can be used as an auxiliary reagent of a catalytic transesterification. However, if the auxiliary reagent is used in trace amounts and a residual acid content of the diol compound is excessive, a catalytic effect of the auxiliary reagent will be negatively affected.

Taiwan Patent Publication No. TWI290537B discloses that an alkali metal hydroxides (e.g., NaOH) can be added into a reactant mixture for synthesizing polycarbonate (PC), thereby increasing an activity of a main catalyst of polyhydrogen polyborate. A dosage amount of the alkali metal hydroxide is approximately between 10⁻⁷ and 10⁻⁵ moles based on per mole of dihydroxyaromatic compound. If the unit of the aforementioned dosage amount of the alkali metal hydroxide is converted into mg KOH/g (i.e., a unit of acid value), an acid value of the alkali metal hydroxide is approximately between 2.4*10⁻⁶ and 2.4*10⁻⁴ mg KOH/g.

However, a residual acid existing in the diol compound (e.g., a dihydroxyaromatic compound like bisphenol A, BPA), may affect the reactivity of the alkali metal hydroxide. Before the transesterification reaction, a concentration of the residual acid in the diol compound should be adjusted to the same level as the dosage amount of the alkali metal hydroxide, so as to prevent the residual acid from affecting the reactivity of the alkali metal hydroxide (e.g., auxiliary catalytic effect).

The conventional standard test method for an acid-base titration is ASTM D664, in which the minimum value of the residual acid value of the prescribed material detected is between 0.05 and 0.1 mgKOH/g, and residual acid with a concentration that is lower than 0.05 mgKOH/g cannot be detected, thereby causing a detection limit to exist. Accordingly, the residual acid in the diol compound cannot be accurately detected, and the conventional standard test method is unable to assess whether the concentration of the residual acid in the diol compound is adjusted to the same level as the concentration of the content of the alkali metal hydroxide. In brief, achieving accurate measurements of acid values below 0.01 mg KOH/g and targeting an accuracy of 0.0001 mg KOH/g presents significant challenges. Furthermore, the presence of residual acidic substances in alcohol-based chemicals may affect the reactivity of catalysts in subsequent chemical reactions, such as to necessitate accurate measurement of the acid value.

### SUMMARY OF THE DISCLOSURE

In response to the above-referenced technical inadequacy, the present disclosure provides a residual acid analysis method for an alcohol compound.

In order to solve the above-mentioned problems, one of the technical aspects adopted by the present disclosure is to provide a residual acid analysis method for an alcohol compound. The residual acid analysis method for an alcohol compound includes an organic solvent preparing process, a titration liquid preparing process, a test sample preparing process, and a titration process. The organic solvent preparing process includes providing an organic solvent and placing the organic solvent into a distillation apparatus to distill the organic solvent and obtain a distilled liquid. The organic solvent preparing process includes excluding an initial fraction consisting of at least initial 10% of the distilled liquid distilled from the distillation apparatus, and collecting a middle fraction of the distilled liquid distilled from the distillation apparatus, so as to obtain a purified organic solvent. The titration liquid preparing process that includes mixing an alkaline inorganic compound and at least a part of the purified organic solvent to form a titration liquid. An equivalent concentration of the alkaline inorganic compound in the titration liquid is not greater than 0.005 N. The test sample preparing process includes mixing a diol compound to be measured and at least another part of the purified organic solvent to form a test sample. The titration process includes using the titration liquid to perform an acid-base titration on the test sample to analyze a residual acid content of the diol compound.

In one of the possible or preferred embodiments, the organic solvent is ethanol, the alkaline inorganic compound is potassium hydroxide, and the diol compound is dihydroxy aromatic compound.

In one of the possible or preferred embodiments, the organic solvent preparing process includes excluding the initial fraction consisting of the initial 10% to 15% of the distilled liquid distilled from the distillation apparatus, collecting the middle fraction consisting of a middle 10% to 15% up to 90% to 95% of the distilled liquid distilled from the distillation apparatus so as to obtain the purified organic solvent, and excluding a final fraction consisting of a final 5% to 10% of the distilled liquid distilled from the distillation apparatus.

In one of the possible or preferred embodiments, the initial fraction of the distilled liquid distilled from the distillation apparatus includes a low boiling point aldehyde compound, and the final fraction of the distilled liquid distilled from the distillation apparatus includes a high boiling point acid compound.

In one of the possible or preferred embodiments, before the organic solvent is distilled by the distillation apparatus, the organic solvent preparing process further includes purging the organic solvent with a nitrogen gas for 10 minutes to 30 minutes, and then distilling the organic solvent by the distillation apparatus under an atmosphere filled with the nitrogen gas.

In one of the possible or preferred embodiments, the equivalent concentration of the alkaline inorganic compound in the titration liquid is between 0.005 N and 0.0001 N.

In one of the possible or preferred embodiments, the equivalent concentration of the alkaline inorganic compound in the titration liquid is between 0.005 N and 0.0005 N.

In one of the possible or preferred embodiments, a weight ratio between the diol compound and the organic solvent in the test sample ranges from 1:1 to 1:4.

In one of the possible or preferred embodiments, the test sample preparing process further includes using a nitrogen gas to purge the test sample before analyzing the residual acid content of the diol compound.

In one of the possible or preferred embodiments, the titration process is performed by a potentiometric titration method.

Therefore, in the residual acid analysis method for the alcohol compound provided by the present disclosure, by virtue of “implementing an organic solvent preparing process that includes providing an organic solvent and placing the organic solvent into a distillation apparatus to distill the organic solvent and obtain a distilled liquid; in which the organic solvent preparing process includes excluding an initial fraction consisting of at least initial 10% of the distilled liquid distilled from the distillation apparatus, and collecting a middle fraction of the distilled liquid distilled from the distillation apparatus, so as to obtain a purified organic solvent,” “implementing a titration liquid preparing process that includes mixing an alkaline inorganic compound and at least a part of the purified organic solvent to form a titration liquid,” “implementing a test sample preparing process that includes mixing a diol compound to be measured and at least another part of the purified organic solvent to form a test sample,” and “implementing a titration process that includes using the titration liquid to perform an acid-base titration on the test sample to analyze a residual acid content of the diol compound,” a detection accuracy for residual acid analysis of the alcohol compound can reach a concentration level that is low enough, so as to improve a limit of the detection.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a residual acid analysis method for an alcohol compound according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In the related art, when polycarbonate is synthesized by a transesterification reaction, an alkali metal hydroxide (e.g., potassium hydroxide or sodium hydroxide) is usually used as a catalyst. However, an excess amount of a residual acid content of the diol compound (e.g., bisphenol A) may affect a catalytic effect of a catalyst. Accordingly, a concentration of the residual acid should be adjusted to the same level as a concentration of a content of the catalyst. The conventional standard test method for an acid-base titration (i.e., ASTM D664) is unable to accurately detect the concentration of the residual acid that is lower than 0.05 mgKOH/g, so that the conventional standard test method is unable to effectively evaluate whether the concentration of the residual acid in the diol compound is adjusted to an appropriate concentration, thereby affecting an efficiency of the transesterification reaction and a quality of a product.

### Residual Acid Analysis Method for Alcohol Compound

To address the technical issues present in the related art, an embodiment of the present disclosure provides a residual acid analysis method for an alcohol compound that achieves a detection accuracy for residual acid analysis down to a concentration level of 0.0001 mg KOH/g.

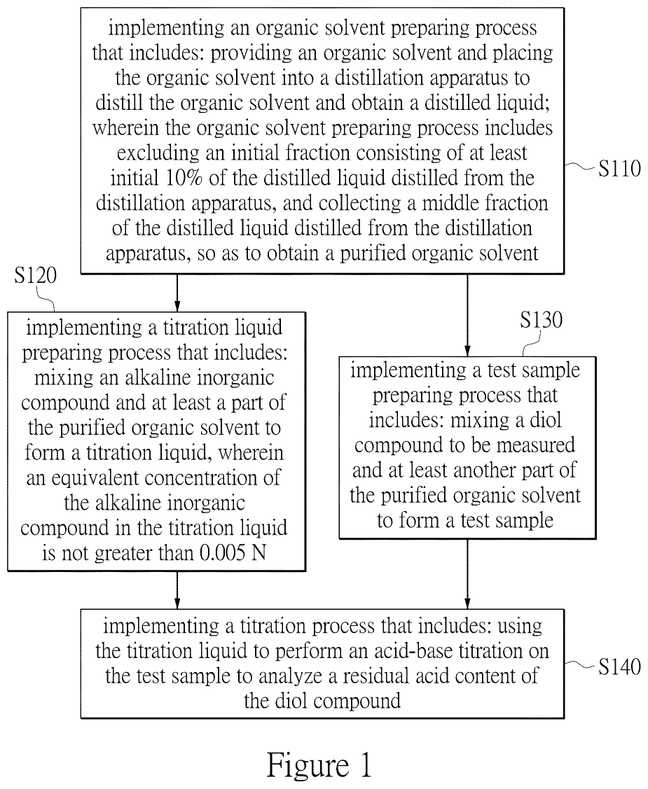

As shown in FIG. 1, the residual acid analysis method for the alcohol compound includes step S110, step S120, step S130, and step S140. It should be noted that sequences of the steps and actual ways of operation described in the present embodiment can be adjusted according to requirements, and are not limited to those of the present embodiment.

Step S110 is to implement an organic solvent preparing process that includes: providing an organic solvent and placing the organic solvent into a distillation apparatus to distill the organic solvent and obtain a distilled liquid.

The organic solvent preparing process includes: excluding (or discharging) an initial fraction of the distilled liquid (e.g., the initial fraction consisting of at least initial 10% and preferably initial 10% to 15% of the distilled liquid) distilled from the distillation apparatus; collecting a middle fraction of the distilled liquid (e.g., the middle fraction consisting of a middle 10% to 15% up to 90% to 95% of the distilled liquid) distilled from the distillation apparatus, so as to obtain a purified organic solvent; and the purified organic solvent is reserved for further use. Furthermore, the organic solvent preparing process includes excluding (or discharging) a final fraction of the distilled liquid (e.g., the final fraction consisting of a final 5% to 10% of the distilled liquid) distilled from the distillation apparatus.

In one embodiment of the present disclosure, 5.0 kilograms of the organic solvent is taken as an example for illustration, the organic solvent preparing process is performed by excluding (or discharging) the initial fraction consisting of the initial 15% of the distilled liquid (i.e., excluding the initial 0.75 kilograms of the distilled liquid); and then collecting the middle fraction consisting of the middle 15% to 95% of the distilled liquid (i.e., collecting the middle 4 kilograms of the distilled liquid) to be a fresh purified organic solvent; and finally excluding the final fraction consisting of the final 5% of the distilled liquid (i.e., excluding the final 0.25 kilograms of distilled liquid).

Moreover, before the organic solvent is distilled by the distillation apparatus, the organic solvent preparing process includes: purging the organic solvent with a nitrogen gas for a predetermined time of between 10 minutes and 30 minutes, thereby removing trace impurities existing in the organic solvent, so as to reduce an influence of the trace impurities to the following residual acid analysis. Then, the organic solvent is distilled by the distillation apparatus under an atmosphere filled with the nitrogen gas, a distillation temperature of the organic solvent distilled by the distillation apparatus is between 75° C. and 80° C., and a gas pressure is at atmospheric pressure.

For example, in the organic solvent preparing process, the organic solvent can be purged by the nitrogen gas through a pipeline of the nitrogen gas being inserted below a liquid level of the organic solvent.

In one embodiment of the present disclosure, the organic solvent can be a monohydric alcohol organic solvent. For example, the organic solvent is ethanol (or anhydrous alcohol).

It is worth mentioning that in the organic solvent preparing process, the initial fraction of the distilled liquid (e.g., the initial 10% to 15% of the distilled liquid) distilled from the distillation apparatus includes a low boiling point compound (e.g., a trace amount of low boiling point aldehyde compound), and the final fraction of the distilled liquid (e.g., the final 5% to 10% of the distilled liquid) distilled from the distillation apparatus includes a high boiling point compound (e.g., a trace amount of high boiling point acid compound). That is, in the organic solvent preparing process, the purified organic solvent collected from the middle fraction of the distilled liquid excludes the trace amount of the aldehyde compound of the initial fraction of the distilled liquid and the trace amount of the acid compound of the final fraction of the distilled liquid, thereby reducing the influence of the aldehyde compound and the acid compound on the following residual acid analysis. Furthermore, the purified organic solvent collected from the middle fraction of the distilled liquid by the aforementioned organic solvent preparing process can be further used in following operations.

Step S120 is to implement a titration liquid preparing process that includes: mixing an alkaline inorganic compound and at least a part of the purified organic solvent of the aforementioned step S110 to form a titration liquid.

In one embodiment of the present disclosure, the alkaline inorganic compound is potassium hydroxide (e.g., a reagent grade or an analytical reagent grade of potassium hydroxide). An equivalent concentration of the alkaline inorganic compound in the titration liquid is not greater than 0.005 N, is preferably between 0.005 N and 0.0001 N, and is more preferably between 0.005 N and 0.0005 N. For example, the equivalent concentration of the alkaline inorganic compound in the titration liquid is 0.00075 N, 0.001 N, 0.002 N, 0.003 N, 0.004 N, or 0.005 N.

When the equivalent concentration of the alkaline inorganic compound in the titration liquid prepared by step S120 is within the aforementioned range, a detection limit of the acid value analysis can be improved in a following titration process, and the detection accuracy of the residual acid analysis can be improved to reach the concentration level of 0.0001 mg KOH/g. Conversely, if the equivalent concentration of the alkaline inorganic compound in the titration liquid is greater than 0.005 N, the detection accuracy of the residual acid analysis cannot reach the concentration level of 0.0001 mg KOH/g.

In addition, in one embodiment of the present disclosure, the titration process further includes placing 0.05 N to 2 N of a hydrochloric acid standard solution (e.g., preferably 0.1 N of the hydrochloric acid standard solution purchased from Sigma-Aldrich) into an ethanol solution to confirm the aforementioned equivalent concentration.

Step S130 is to implement a test sample preparing process that includes: mixing a diol compound to be measured and at least another part of the purified organic solvent of the aforementioned step S110 to form a test sample in a liquid state. Specifically, the diol compound to be measured has an unknown residual acid content.

Furthermore, a weight ratio between the diol compound and the organic solvent ranges from 1:1 to 1:4, and preferably ranges from 1:1 to 1:2.

For example, the test sample preparing process can include using 1 kilogram of the diol compound to mix with 2 kilograms of the purified organic solvent to form the test sample, but the present disclosure is not limited thereto.

Specifically, the diol compound is further limited to a dihydroxy aromatic compound. For example, the diol compound is bisphenol A (BPA).

In one embodiment of the present disclosure, the test sample preparing process further includes placing the diol compound and the purified organic solvent into a container (e.g., three neck flask), and mixing the diol compound and the purified organic solvent under an atmosphere filled with the nitrogen gas. In terms of sequences for adding materials, the diol compound is added first, and then the purified organic solvent is added under the atmosphere filled with the nitrogen gas, thereby forming the test sample. Specifically, a liquid temperature for mixing the diol compound and the purified organic solvent is maintained between 20° C. and 25° C., but the present disclosure is not limited thereto.

In one embodiment of the present disclosure, before conducting the following acid value analysis of the test sample that is prepared, the test sample preparing process further includes using another nitrogen gas to purge the test sample for a predetermined time of between 10 minutes and 30 minutes, so that the impurities possibly existing in the diol compound can be removed, thereby reducing the influence of the impurities on the following residual acid analysis.

Furthermore, in the test sample preparing process, the test sample can be purged by the nitrogen gas through a pipeline of the nitrogen gas being inserted below a liquid level of the test sample.

It is worth mentioning that the purified organic solvent of the aforementioned step S110 is preferably used within 24 hours (i.e., to form the titration liquid with the alkaline inorganic compound of step S120, and/or to form the test sample with the diol compound of step S130), so as to prevent the organic solvent from reacting with carbon dioxide in the air to generate the impurities, which may affect an accuracy of the detection.

Step S140 is to implement a titration process that includes using the titration liquid of step S120 to perform an acid-base titration on the test sample of step S130, and calculating an acid value of the diol compound (e.g., a residual acid content of the diol compound) after reaching a titration end point of the test sample. It is worth mentioning that the titration process performs the acid-base titration by a potentiometric titration method.

According to the aforementioned technical solutions, the detection accuracy of the residual acid analysis method for the alcohol compound provided by the present embodiment can reach the concentration level of 0.0001 mg KOH/g.

For example, the residual acid analysis method for the alcohol compound provided by the present embodiment can accurately quantify the residual acid in the diol compound (e.g., BPA), so that when the diol compound is shipped to downstream production departments or clients, a message of the acid value can be provided with the detection accuracy achieving 0.0001 mg KOH/g.

### Experimental Data and Test Results

To prove the technical effects of the residual acid analysis method for the alcohol compound of the present embodiment, a description will be provided with the experimental data and the test results below. However, the scope of the present disclosure is not limited thereto.

### Exemplary Example 1

A solvent purification process is implemented by placing 5 kilograms of anhydrous alcohol (e.g., ethanol) into a distillation apparatus; distilling the anhydrous alcohol under an atmosphere filled with a nitrogen gas; excluding an initial fraction consisting of the initial 15% (i.e., 0.75 kilograms) of a distilled liquid; collecting a middle fraction consisting of the middle 15% to 95% (i.e., 4 kilograms) of the distilled liquid as a purified anhydrous alcohol to be reserved; and excluding a final fraction consisting of the final 5% (i.e., 0.25 kilograms) of the distilled liquid. A titration liquid preparation process is implemented by mixing potassium hydroxide (KOH) with the aforementioned purified anhydrous alcohol to prepare a titration liquid in a KOH concentration of 0.005 N. The concentration of KOH in the titration liquid is confirmed by 0.1 N of HCl (i.e., Sigma-Aldrich chloride standard prepared in an ethanol solution). A test sample preparation process is implemented by placing 1 kilogram of a BPA sample having an unknown residual acid content into a three neck flask; and placing 2 kilograms of the purified anhydrous alcohol into the three neck flask under an atmosphere filled with the nitrogen gas; stirring the BPA sample and the purified anhydrous alcohol uniformly to form a mixed liquid; and inserting a pipe of the nitrogen gas below a liquid level of the mixed liquid to purge the mixed liquid for 15 minutes, so as to form a test sample. Specifically, a liquid temperature of the test sample is maintained between 20° C. and 25° C. An acid value analysis is implemented by conducting a potentiometric titration on 150 grams of the BPA test sample using the titration liquid, and the acid value analysis is analyzed by a KEM (Kyoto Electronics Manufacturing Co., Ltd.) of automatic potentiometric titrator. A unit of the acid value is 10E⁻³ mgKOH/g, and the acid value is calculated as follows.

$$Acid value = ( Volume of KOH consumed ( cc ) \times f \times 56.1 ) / ( Liquid weight of test sample ) .$$

Specifically, the volume of KOH consumed (cc) refers to the volume of an alkaline solution (potassium hydroxide, KOH) used in the titration after the addition of the test sample, measured in cubic centimeters or milliliters. The f is the standard equivalent factor for KOH The number 56.1 represents the molar mass of potassium hydroxide (KOH) in milligrams that is used to convert the unit of the consumption of KOH from volume to mass, thereby calculating an amount (mg) of KOH needed to neutralize free fatty acids in the test sample. The liquid weight (g) of the test sample is a mass of the test sample (in grams). The acid value is carried out by calculating a mass of potassium hydroxide (after considering adjusting equivalence factors) required in specific conditions to neutralize a ratio of the free fatty acids in the test sample. Finally, the unit of the acid value is expressed in mgKOH/g, which is a quantitative indicator that directly reflects a content of the free fatty acids in lipids or other substances.

The preparation methods for Exemplary Example 2 to Exemplary Example 8 are approximately the same as the aforementioned Exemplary Example 1, and the differences lie in the concentration of the KOH in the titration liquid and the titration amount of the test sample, as shown in Table 1 below.

TABLE 1

| Exemplary Example | 1 | 2 | 3 | 4 | 5 | 6 | 7 | 8 |
|---|---|---|---|---|---|---|---|---|
| Concentration | 0.005 | 0.001 | 0.001 | 0.001 | 0.0001 | 0.01 | 0.01 | 0.01 |
| of KOH in the | | | | | | | | |
| titration | | | | | | | | |
| liquid (N) | | | | | | | | |
| BPA sample (g) | 100 | 50 | 75 | 100 | 50 | 50 | 75 | 100 |
| Acid value | 15.6923 | 13.12053 | 13.2314 | 13.18183 | 28.04645 | Unable to | Unable to | Unable to |
| in 10E⁻³ | | | | | | determine | determine | determine |
| mgKOH/g | | | | | | the | the | the |
| | | | | | | titration | titration | titration |
| | | | | | | end point | end point | end point |

As shown in the experimental data of Table 1, Exemplary Examples 1 to 4 include using the titration liquid with the centration of KOH that is between 0.001 N and 0.005 N to analyze the acid value that is approximately between 13.1205 and 15.6923*10E⁻³ mgKOH/g, which indicates that stable and sufficiently low concentration levels of acid value measurements can be detected.

Furthermore, Exemplary Examples 2 to 4 include using 0.001 N of KOH in the titration liquid to analyze different grams (i.e., between 50 g and 100 g) of the BPA test sample to obtain approximately the same acid value measurement results. Exemplary Example 5 includes using 0.0001 N of KOH in the titration liquid to measure a higher acid value, but is still within an acceptable range of the analytical results.

As shown in the experimental data of Table 1, using the purified anhydrous alcohol from distillation to prepare the titration liquid and the test sample, and using the titration liquid with the concentration of KOH that is between 0.0001 N and 0.005 N can analyze the acid value of the BPA test sample.

Furthermore, Exemplary Examples 6 to 8 include using 0.01 N of KOH in the titration liquid. Since the concentration of the KOH in the titration liquid is too high, the titration end point cannot be determined. That is, if the concentration of the KOH in the titration liquid is greater than 0.005 N, the acid value may not be accurately analyzed.

It is worth mentioning that in a Comparative Example, an undistilled (unpurified) solvent is used and the remaining conditions (e.g., the preparing process of the titration liquid and the test sample) are same as the aforementioned Experimental Example 1. The measurement results of the Comparative Example show that the titration end point cannot be determined. Accordingly, the acid value cannot be analyzed.

### Beneficial Effects of the Embodiment

In conclusion, the residual acid analysis method for an alcohol compound provided by the present disclosure, by virtue of “implementing an organic solvent preparing process that includes providing an organic solvent and placing the organic solvent into a distillation apparatus to distill the organic solvent and obtain a distilled liquid; in which the organic solvent preparing process includes excluding an initial fraction consisting of at least initial 10% of the distilled liquid distilled from the distillation apparatus, and collecting a middle fraction of the distilled liquid distilled from the distillation apparatus, so as to obtain a purified organic solvent,” “implementing a titration liquid preparing process that includes mixing an alkaline inorganic compound and at least a part of the purified organic solvent to form a titration liquid,” “implementing a test sample preparing process that includes mixing a diol compound to be measured and at least another part of the purified organic solvent to form a test sample,” and “implementing a titration process that includes using the titration liquid to perform an acid-base titration on the test sample to analyze a residual acid content of the diol compound,” a detection accuracy for residual acid analysis of the alcohol compound can reach a concentration level that is low enough, so as to improve the detection limit.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A residual acid analysis method for an alcohol compound, comprising:
implementing an organic solvent preparing process that includes: providing an organic solvent and placing the organic solvent into a distillation apparatus to distill the organic solvent and obtain a distilled liquid; wherein the organic solvent preparing process includes excluding an initial fraction consisting of at least initial 10% of the distilled liquid distilled from the distillation apparatus, and collecting a middle fraction of the distilled liquid distilled from the distillation apparatus, so as to obtain a purified organic solvent;
implementing a titration liquid preparing process that includes: mixing an alkaline inorganic compound and at least a part of the purified organic solvent to form a titration liquid, wherein an equivalent concentration of the alkaline inorganic compound in the titration liquid is not greater than 0.005 N;
implementing a test sample preparing process that includes: mixing a diol compound to be measured and at least another part of the purified organic solvent to form a test sample; and
implementing a titration process that includes: using the titration liquid to perform an acid-base titration on the test sample to analyze a residual acid content of the diol compound.

2. The residual acid analysis method for the alcohol compound according to claim 1, wherein the organic solvent is ethanol, the alkaline inorganic compound is potassium hydroxide, and the diol compound is dihydroxy aromatic compound.

3. The residual acid analysis method for the alcohol compound according to claim 1, wherein the organic solvent preparing process includes excluding the initial fraction consisting of initial 10% to 15% of the distilled liquid distilled from the distillation apparatus; collecting the middle fraction consisting of a middle 10% to 15% up to 90% to 95% of the distilled liquid distilled from the distillation apparatus so as to obtain the purified organic solvent; and excluding a final fraction consisting of a final 5% to 10% of the distilled liquid distilled from the distillation apparatus.

4. The residual acid analysis method for the alcohol compound according to claim 3, wherein the initial fraction of the distilled liquid distilled from the distillation apparatus includes a low boiling point aldehyde compound, and the final fraction of the distilled liquid distilled from the distillation apparatus includes a high boiling point acid compound.

5. The residual acid analysis method for the alcohol compound according to claim 1, wherein, before the organic solvent is distilled by the distillation apparatus, the organic solvent preparing process further includes: purging the organic solvent with a nitrogen gas for 10 minutes to 30 minutes, and then distilling the organic solvent by the distillation apparatus under an atmosphere filled with the nitrogen gas.

6. The residual acid analysis method for the alcohol compound according to claim 1, wherein the equivalent concentration of the alkaline inorganic compound in the titration liquid is between 0.005 N and 0.0001 N.

7. The residual acid analysis method for the alcohol compound according to claim 6, wherein the equivalent concentration of the alkaline inorganic compound in the titration liquid is between 0.005 N and 0.0005 N.

8. The residual acid analysis method for the alcohol compound according to claim 1, wherein a weight ratio between the diol compound and the organic solvent in the test sample ranges from 1:1 to 1:4.

9. The residual acid analysis method for the alcohol compound according to claim 1, wherein the test sample preparing process further includes using a nitrogen gas to purge the test sample before analyzing the residual acid content of the diol compound.

10. The residual acid analysis method for the alcohol compound according to claim 1, wherein the titration process is performed by a potentiometric titration method.
